(19) United States
(12) Patent Application Publication
(10) Pub. No.: US 2025/0038461 A1
(43) Pub. Date: Jan. 30, 2025

(54) CONNECTOR

(71) Applicant: Yazaki Corporation, Tokyo (JP)

(72) Inventors: Kozo OISHI, Shizuoka (JP); Jun ISHIKAWA, Tokyo (JP)

(73) Assignee: Yazaki Corporation, Tokyo (JP)

(21) Appl. No.: 18/775,224

(22) Filed: Jul. 17, 2024

(30) Foreign Application Priority Data
Jul. 24, 2023 (JP) 2023-119977

(51) Int. Cl. H01R 13/6599; H01R 13/52

(52) U.S. Cl. CPC H01R 13/6599; H01R 13/5216; H01R 2201/26

(57) ABSTRACT

A connector includes: a connection member, which is formed of a conductive metal material, having a plurality of tabs; and a resin housing in which a portion of the connection member is insert molded. The connection member includes: a fixed plate fixed to a vehicle; a support plate raised from the fixed plate; and a base part connected continuously to the support plate and in which the plurality of tabs are formed so as to project. A pair of reinforcing ribs raised from the fixed plate is formed on both sides of the fixed plate in a width direction, and each of the reinforcing ribs is partially covered by a covering part projecting from the housing.

### CROSS-REFERENCE TO RELATED APPLICATIONS

The present application is based on, and claims priority from the prior Japanese Patent Application No. 2023-119977, filed on Jul. 24, 2023, the entire contents of which are incorporated herein by reference.

### TECHNICAL FIELD

The present disclosure relates to a connector.

### BACKGROUND

As a ground joint connector for connecting a plurality of electric wires together to a ground portion of a vehicle, there is a connection member, which is formed of a conductive metal material, having a plurality of tabs, and the connection member is integrally provided in a housing made of resin (see JP2016-110713A). The connection member includes a fixed plate fixed to the vehicle, a support plate raised from the fixed plate, and a base part connected continuously to the support plate and in which a plurality of tabs are formed so as to project.

### SUMMARY OF THE INVENTION

In the ground joint connector, since the fixed plate of the connection member is firmly fixed to the vehicle body by bolts or the like, both vibration from the body and vibration from the electric wire are transmitted to the connection member, and thus stress may be concentrated near the fixed plate of the connection member.

An object of the present disclosure is to provide a connector capable of suppressing damage to a connection member due to repeated vibrations of a vehicle.

A connector according to an embodiment includes: a connection member, which is formed of a conductive metal material, having a plurality of tabs; and a resin housing in which a portion of the connection member is insert molded. The connection member includes: a fixed plate fixed to a vehicle; a support plate raised from the fixed plate; and a base part connected continuously to the support plate and in which the plurality of tabs are formed so as to project. A pair of reinforcing ribs raised from the fixed plate is formed on both sides of the fixed plate in a width direction, and each of the reinforcing ribs is partially covered by a resin part projecting from the housing.

The above configuration makes it possible to provide a connector capable of suppressing damage to a connection member due to repeated vibrations of a vehicle.

### BRIEF DESCRIPTION OF DRAWINGS

FIG. 1 is a perspective view illustrating an example of a ground joint connector according to a present embodiment.

FIG. 2 is a side view illustrating an example of the ground joint connector according to the present embodiment.

FIG. 3 is an exploded perspective view illustrating an example of the ground joint connector according to the present embodiment.

FIG. 4 is a perspective view illustrating an example of a male connector according to the present embodiment.

FIG. 5 is a front view illustrating an example of the male connector according to the present embodiment.

FIG. 6 is a cross-sectional view taken along line A-A of FIG. 5.

FIG. 7 is a cross-sectional view taken along line B-B of FIG. 5.

FIG. 8 is a perspective view of a ground terminal member.

FIG. 9 is a perspective view of the ground terminal member viewed from the opposite side of FIG. 8.

FIG. 10 is a side view of the ground terminal member.

FIG. 11 is a perspective view of a blank material before forming the ground terminal member.

FIG. 12 is a plan view of the blank material before forming the ground terminal member.

FIG. 13A is an explanatory view of a process for applying a water stop material to the ground terminal member.

FIG. 13B is an explanatory view of a process for applying a water stop material to the ground terminal member.

### DETAILED DESCRIPTION OF THE INVENTION

Hereinafter, a connector according to a present embodiment will be described in detail with reference to the drawings. Note that the dimensional ratio of the drawings is exaggerated for the sake of explanation, and may differ from the actual ratio.

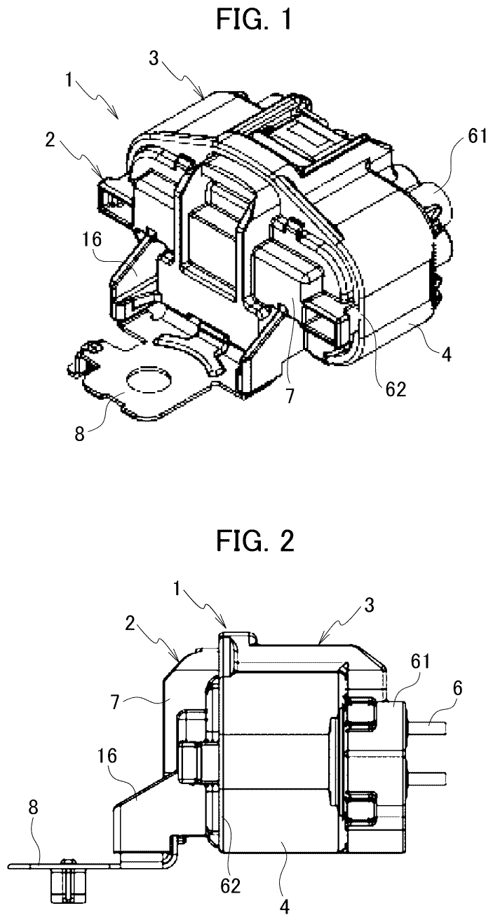

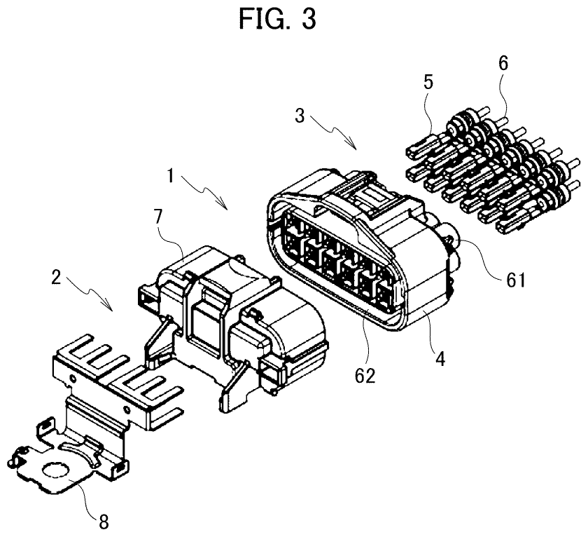

As illustrated in FIGS. 1 to 3, a ground joint connector 1 is formed by combining a connector (a male connector 2) and a mating connector (a female connector 3). The mating connector (the female connector 3) is fitted with the connector (the male connector 2) according to the present embodiment.

First, the mating connector (the female connector 3) will be described.

The female connector 3 includes a mating housing made of resin (a female housing 4). The female housing 4 has a plurality of terminal accommodating chambers 61, and the distal end side of the female housing 4 is a fitting part 62. The plurality of terminal accommodating chambers 61 are formed along the joining direction with the male connector 2. Further, the plurality of terminal accommodating chambers 61 are arranged in the female housing 4 in the width direction, and the plurality of terminal accommodating chambers 61 are arranged in two upper and lower stages.

In the terminal accommodating chamber 61, a female terminal 5 is accommodated (inserted) from the rear end side which is the rear side in the joining direction with the male connector 2. The female terminal 5 is formed of a conductive metal material such as copper or copper alloy. An electric wire 6 having an outer skin covering around the conductor is crimped and electrically connected to the female terminal 5. The female terminal 5 is inserted into the terminal accommodating chamber 61 from the rear end side of the female housing 4, and thus the electric connection part of the female terminal 5 is locked to a lance part (not illustrated) in the terminal accommodating chamber 61. As a result, the female terminal 5 is held in a state in which it is housed in the terminal accommodating chamber 61.

Next, the connector (the male connector 2) will be described.

The male connector 2 includes a housing made of resin (a male housing 7). The male housing 7 is formed with a fitting recess 11 in which the tip-end side, which is the front side in the joining direction with the female connector 3, has an opening. When a fitting part 62 of the female housing 4 is fitted with the fitting recess 11 of the male housing 7, the mating connector (the female connector 3) is joined to the connector (the male connector 2).

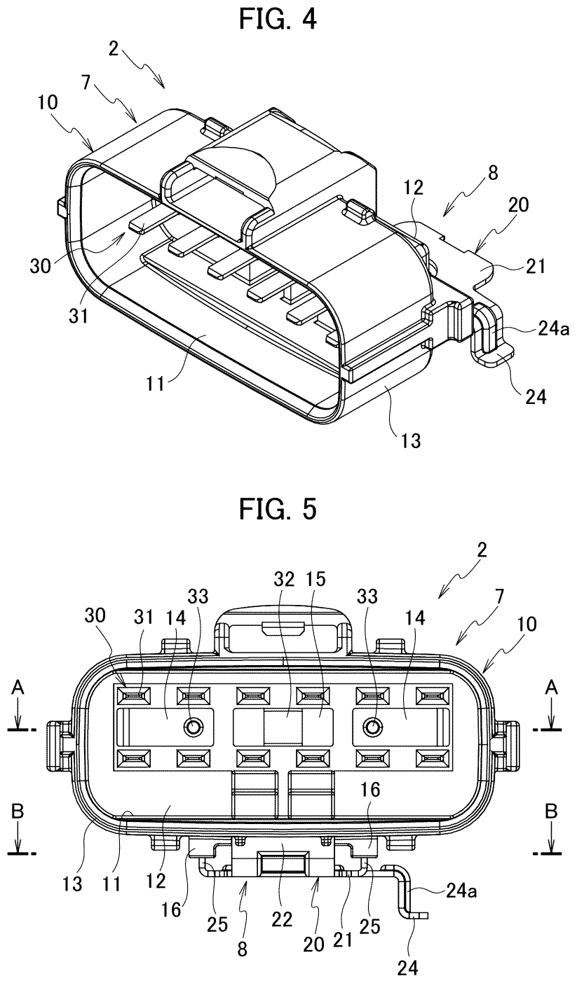

As illustrated in FIGS. 4 to 7, the male connector 2 has a housing (the male housing 7) and a connection member (a ground terminal member 8).

The male housing 7 has a hood 10, and the inner side of the hood 10 is the fitting recess 11. The hood 10 has a rear wall (a bottom wall 12), and a peripheral wall 13 extending from the periphery of the bottom wall 12 to the tip-end side thereof. A packing formed into an annular shape (not illustrated) is fitted into the hood 10 of the male housing 7. When the fitting part 62 of the female housing 4 is fitted with the fitting recess 11 of the male housing 7, the packing stops water between the fitting recess 11 and the fitting part 62.

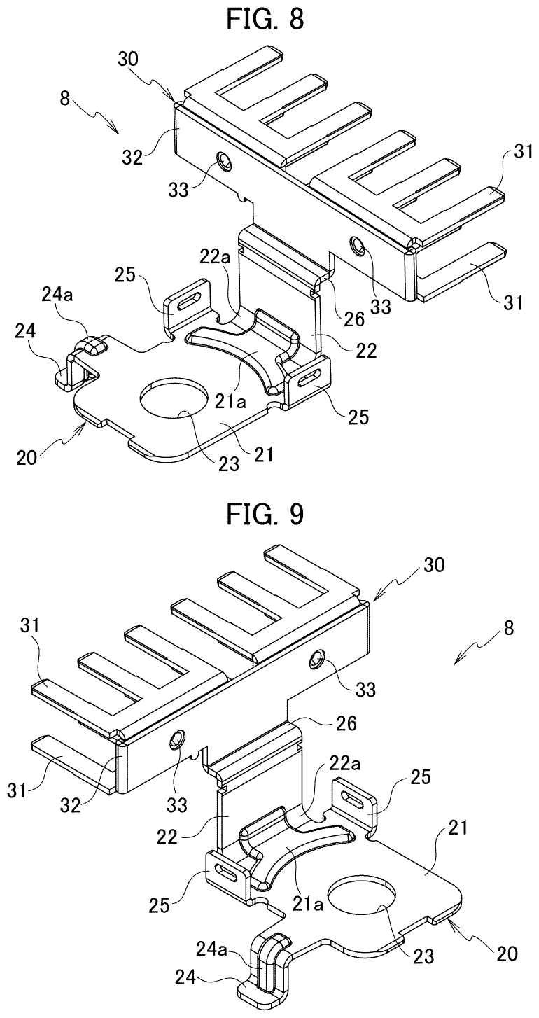

As illustrated in FIGS. 8 to 10, the ground terminal member 8 includes a bus bar 20 and a terminal fitting 30. The bus bar 20 and the terminal fitting 30 are formed of a conductive metal material such as copper or a copper alloy, and are integrally formed by pressing.

The bus bar 20 has a flat fixed plate (a body fixed part 21), and a support plate (a neck 22) raised from the body fixed part 21. A bolt insertion hole 23 is formed in the body fixed part 21. The body fixed part 21 is fastened and fixed to the vehicle body (body) by fastening a bolt (not illustrated) inserted into the bolt insertion hole 23 to the vehicle body (body), and thus the bus bar 20 is grounded. In addition, the ground terminal of the ground wire (not illustrated) is jointly fastened to the body fixed part 21 by a bolt. A portion of the body fixed part 21 is formed with a rotation stopper piece 24. The rotation stopper piece 24 is a bent part engaged with a step part or a hole part around the grounding surface where the body fixed part 21 is fastened by a bolt, and the rotation of the body fixed part 21 with respect to the grounding surface is controlled when the rotation stopper piece 24 is engaged with a step part or a hole part around the grounding surface.

A convex part 21a for increasing the rigidity of the bus bar 20 is formed from the body fixed part 21 to the neck 22. In addition, a convex part 24a for increasing the rigidity of the rotation stopper piece 24 is formed in the rotation stopper piece 24.

At the end part of the neck 22 side (a portion near the neck 22) in the body fixed part 21, ribs (reinforcing ribs 25) raised vertically from the body fixed part 21 are formed on both sides in the width direction. At least, the upper part of each of the reinforcing ribs 25 and 25 is covered by a resin part (a covering part 16) projecting from the male housing 7 (see FIGS. 1 and 2). When vibration is applied in a state in which the ground joint connector 1 is fixed to the vehicle body, a large load may be repeatedly applied to a root part 22a positioned between the neck 22 and the body fixed part 21 of the ground terminal member 8 by vibration transmitted through the female connector 3. The ground terminal member 8 having the structure described above makes it possible to distribute the load applied to the ground terminal member 8 through the female connector 3, thereby preventing the load from being concentrated at the root part 22a of the neck 22 of the ground terminal member 8.

In the ground joint connector 1, a current supplied from the female connector 3 passes through a plurality of tabs 31 of the ground terminal member 8, merges at the neck 22, and is supplied from the body fixed part 21 to the vehicle body. At this time, the amount of heat generated in the neck 22 may increase due to the concentration of the current in the neck 22. Since the ground terminal member 8 has a structure having the ribs (the reinforcing ribs 25) described above, the effect of heat dissipation can be obtained by the ribs (the reinforcing ribs 25), thereby making it possible to reduce the amount of heat generated in the neck 22 and suppress an increase in temperature.

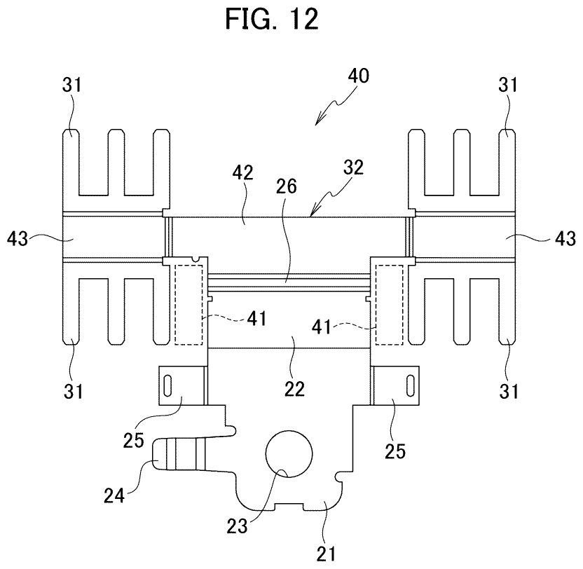

Here, when the reinforcing ribs 25 are arranged on both sides of the neck 22 in the width direction (the portions indicated by reference numerals 41 and 41 in FIG. 12), the height of the reinforcing ribs 25 cannot be secured because the tabs 31 are positioned on the outer sides in the width direction in a blank material 40 (a plate member before forming the ground terminal member 8 by bending). In contrast, in the present embodiment, since the reinforcing ribs 25 are arranged on both sides of the body fixed part 21 in the width direction, the tabs 31 are not present on the outer sides in the width direction in the blank material 40, thereby making it possible to secure the height of the reinforcing ribs 25 (see FIG. 12). In addition, since the reinforcing ribs 25 are arranged in an area that would conventionally be discarded without being used, the material yield can be improved.

Further, a crank part 26 formed by being bent into a crank shape is formed at the end part of the neck 22 on the terminal fitting 30 side (a portion near the terminal fitting 30).

The terminal fitting 30 has a base part 32 and a plurality of tabs 31. The base part 32 is formed into a flat plate shape, and the tabs 31 project from the edge part of the base part 32 in the same direction. In the ground terminal member 8, the plurality of tabs 31 projecting in the direction orthogonal to the surface of the base part 32 are arranged in two upper and lower stages.

As illustrated in FIGS. 4 to 7, the ground terminal member 8 is insert molded into the male housing 7. As a result, the ground terminal member 8 is integrally formed in such a state that the neck 22 of the bus bar 20 and the base part 32 of the terminal fitting 30 are embedded in the bottom wall 12 forming the fitting recess 11 of the male housing 7. The tabs 31 of the ground terminal member 8 project from the bottom wall 12 into the fitting recess 11.

The ground terminal member 8 is formed by punching out a metal plate material to make the blank material 40 (see FIGS. 11 and 12), and applying a bending process or the like to the blank material 40. As illustrated in FIGS. 11 and 12, the blank material 40 has the bus bar 20 formed at one end side of the blank material 40, the terminal fitting 30 formed at the other end side of the blank material 40, and the neck 22 formed between the bus bar 20 and the terminal fitting 30.

The base part 32 of the terminal fitting 30 also has a first base part 42, and a pair of second base parts 43 and 43 connected continuously to each side of the first base part 42 in the width direction. The tabs 31 are formed at each of the second base parts 43, and the root parts of the second base parts 43 are folded back to overlap the first base part 42. Thereafter, by partially crimping (riveting) the overlapped portion of the first base part 42 and the second base parts 43, rivet-retaining parts 33 in which each of the second base parts 43 is fixed to the first base part 42 are formed (see FIGS. 8 and 9).

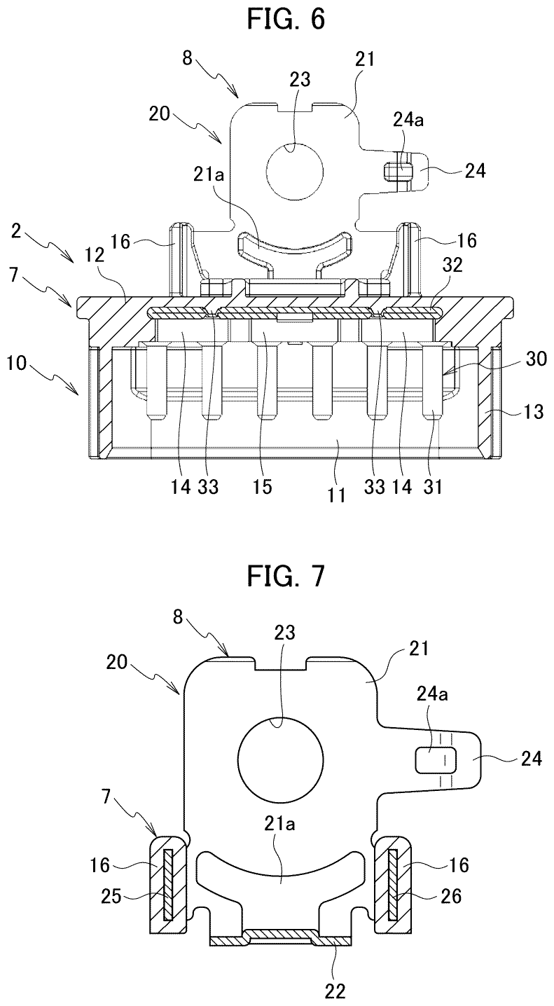

In the present embodiment, the center portion of the rivet retaining parts 33 and the base part 32 in the width direction is not covered by resin (a portion of the male housing 7), but is exposed by the exposed parts (the reduced-thickness parts 14 and 15) (see FIGS. 5 and 6). Since the rivet retaining parts 33 are exposed by the reduced-thickness parts 14 after insert molding, the portion which is not riveted can be detected by the appearance inspection after insert molding. In addition, as compared with the case where the rivet retaining parts 33 are covered by resin, the amount of resin to be used is reduced, thereby reducing the weight of the male connector 2.

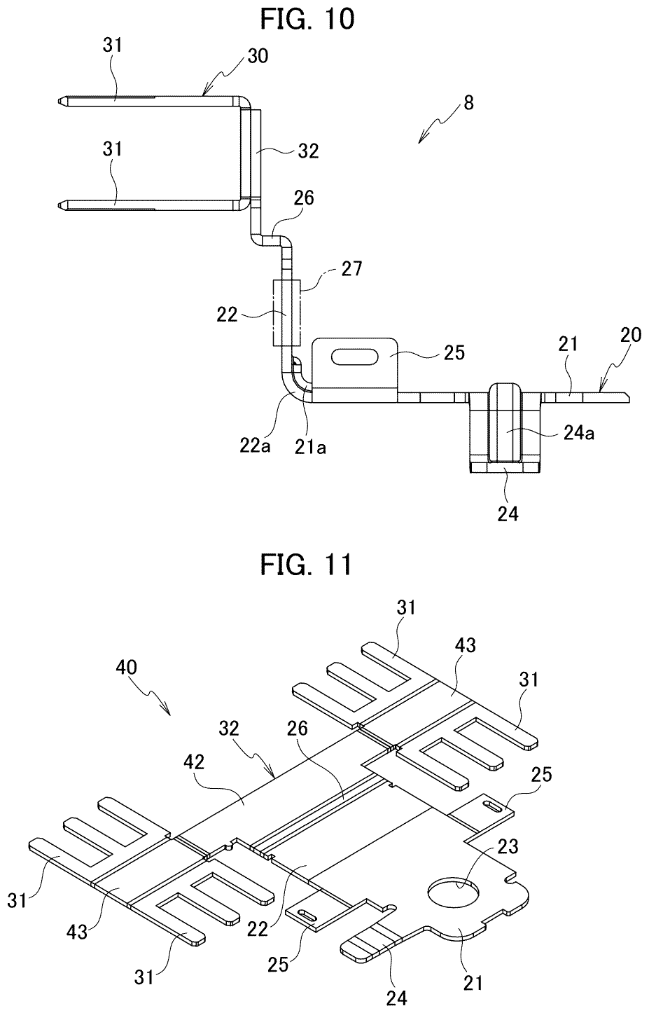

Meanwhile, in the male housing 7, the resin shrinks after insert molding, thereby reducing the overall volume of the male housing 7. In addition, the ground terminal member 8 heated and thermally expanded during insert molding also decreases in volume after insert molding. However, since a volume decrease rate of the male housing 7 is greater than a volume decrease rate of the ground terminal member 8, a minute gap may occur between the ground terminal member 8 and the male housing 7 in the male connector 2 due to the difference in these volume decrease rates. Accordingly, in a state where a water stop material coating part 27 (see FIG. 10) is formed around the entire circumference of the neck 22 of the ground terminal member 8, insert molding is performed on the ground terminal member 8.

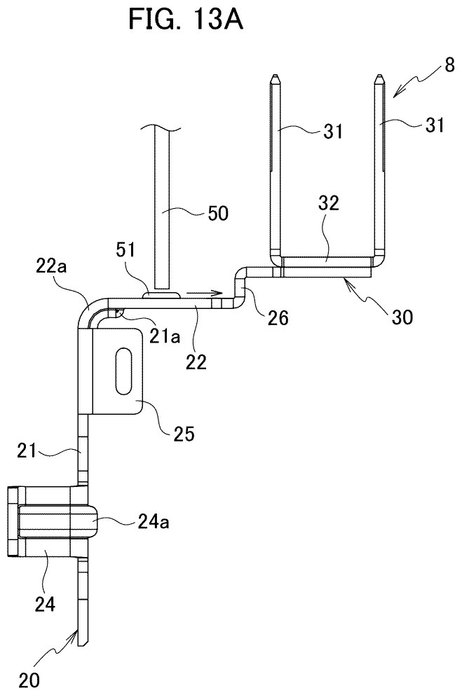

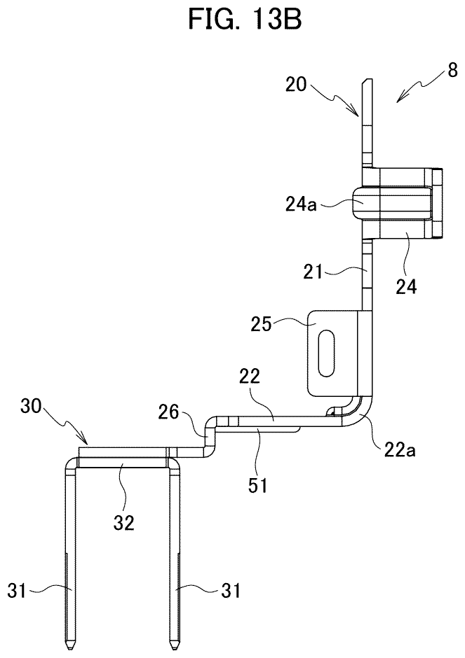

A water stop material 51 (see FIG. 13A) is applied to the ground terminal member 8 at a stage before insert molding. For example, the water stop material 51 used here has the property that it is in liquid form at the time it is applied to the ground terminal member 8 and solidifies as it dries. First, as illustrated in FIG. 13A, the ground terminal member 8 is arranged with the tabs 31 facing upward, and the water stop material 51 is applied to the neck 22 of the bus bar 20 by using a nozzle 50 such as a dispenser. At this time, since the crank part 26 formed by being bent into a crank shape is formed at the end part of the neck 22 on the terminal fitting 30 side (a portion near the terminal fitting 30), the water stop material 51 can be suppressed from flowing into the tabs 31 by the crank part 26. Thereafter, as illustrated in FIG. 13B, the ground terminal member 8 is arranged with the tabs 31 facing downward, and the water stop material 51 is also applied to the opposite surface of the neck 22 of the bus bar 20 by using the nozzle 50.

As described above, the connector (the male connector 2) according to an aspect of the present embodiment includes the connection member (the ground terminal member 8), which is formed of a conductive metal material, having the plurality of tabs 31. The connector (the male connector 2) includes the resin housing (the male housing 7) in which a portion of the connection member (the ground terminal member 8) is insert molded. The connection member (the ground terminal member 8) includes the fixed plate (the body fixed part 21) fixed to a vehicle, and the support plate (the neck 22) raised from the fixed plate (the body fixed part 21). The connection member (the ground terminal member 8) includes the base part 32 connected continuously to the support plate (the neck 22) and in which the plurality of tabs 31 are formed so as to project. The pair of reinforcing ribs 25 and 25 raised from the fixed plate (the body fixed part 21) is formed on both sides of the fixed plate (the body fixed part 21) in the width direction. Each of the reinforcing ribs 25 and 25 is partially covered by the resin part (the covering part 16) projecting from the housing (the male housing 7).

In the present embodiment, the pair of reinforcing ribs 25 and 25 raised from the body fixed part 21 is formed on both sides of the body fixed part 21 in the width direction, and each of the reinforcing ribs 25 and 25 is partially covered by the covering part 16 projecting from the male housing 7. The ground terminal member 8 having the structure described above makes it possible to distribute a load applied to the ground terminal member 8 due to vibration of a vehicle or the like, thereby preventing the load from being concentrated at the root part 22a of the neck 22 of the ground terminal member 8. In addition, since the reinforcing ribs 25 are arranged in an area that would conventionally be discarded without being used, the material yield can be improved (see FIG. 12).

As described above, the present embodiment makes it possible to provide a connector (the male connector 2) capable of suppressing damage to a connection member (the ground terminal member 8) due to repeated vibrations of a vehicle.

In the connector (the male connector 2), each of the reinforcing ribs 25 and 25 may be raised vertically from the fixed plate (the body fixed part 21).

When the pair of reinforcing ribs 25 and 25 is arranged in the body fixed part 21 as described above, the ground terminal member 8 can be effectively reinforced by the pair of reinforcing ribs 25 and 25.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a connection member, which is formed of a conductive metal material, having a plurality of tabs; and
a resin housing in which a portion of the connection member is insert molded,
wherein the connection member includes:
a fixed plate fixed to a vehicle;
a support plate raised from the fixed plate; and
a base part connected continuously to the support plate and in which the plurality of tabs are formed so as to project,
a pair of reinforcing ribs raised from the fixed plate is formed on both sides of the fixed plate in a width direction, and
each of the reinforcing ribs is partially covered by a resin part projecting from the housing.

2. The connector according to claim 1,
wherein each of the reinforcing ribs is raised vertically from the fixed plate.
